(19) United States
(12) Patent Application Publication
(10) Pub. No.: US 2001/0048413 A1
(43) Pub. Date: Dec. 6, 2001

(54) Display device, method of adjusting a display device, and a cellular phone

(75) Inventor: Seiichirou Tabata, Tokyo (JP)

Correspondence Address: John C. Pokotylo, STRAUB & POKOTYLO, Suite 56, 1 Bethany Road, Hazlet, NJ, 07730, US

(73) Assignee: Olympus Optical Co., Ltd.

(21) Appl. No.: 09/858,536

(22) Filed: May 16, 2001

(30) Foreign Application Priority Data
Jun. 5, 2000 (JP) 2000-167803

(51) Int. Cl. G09G 3/36

(52) U.S. Cl. 345/87

(57) ABSTRACT

The present invention discloses a display device including left and right projection units which are configured as combining a plurality of LCD, a plurality of back lights for illuminating the plurality of LCD, respectively, a plurality of lens arrays for projecting the images on each LCDs illuminated by the back lights, and a screen on which images from the left and right projection units are projected onto each separate areas. The screen is capable of folding at a folding line corresponding between the projection units themselves, and each projection units are configured to move in an approximately integral with each areas of the screen which are partitioned by the folding line, and as being capable of taking a close position and an open position as a whole.

This application claims benefit of Japanese Application No. 2000-167803 filed in Japan on Jun. 5, 2000, the contents of which are incorporated by this reference.

### BACKGROUND OF THE INVENTION

1. Field of the Invention

The present invention relates to a display device, a method of adjusting the display device, and a cellular phone, and more particularly, to the display device for projecting an image on a display element onto a screen by a lens array, the method of adjusting the display device, and the cellular phone.

2. Description of the Related Art

Conventionally, various kinds of foldable devices, which are equipped with display devices, have been proposed and manufactured.

As an example of such devices, for example, in the Registered Design Publication No. 1041297, there is disclosed a portable information communication device which is capable of receiving a facsimile or a mail, producing a simple text, transmitting an image taken by a camera with a facsimile or a mail and the like, besides having a function as a cellular phone, and which is configured as being able to open/close a lid-shaped part provided with a sub-screen against a main frame provided with a main screen, by a hinge and the like.

However, in the one disclosed in the Registered Design Publication No. 1041297, the main screen and the sub-screen are entirely independent screens each other, and are not configured to display one image as a whole. Even if, by dividing one image into two images and displaying one image on the main screen and the other image on the sub-screen, because two images are separated in a predetermined distance by sandwiching an exterior member, it is not possible to observe a whole image as one image.

### SUMMARY OF THE INVENTION

Accordingly, it is an object of the present invention to provide a display device which is capable of folding, a method of adjusting the display device, and a cellular phone.

The above-mentioned object of the present invention can be achieved by a display device including a plurality of projection units being configured as combining a display element, and a lens array for projecting an image on the display element, as to be in a predetermined positional relationship, a screen of which images from the plurality of projection units are projected onto each separate areas, wherein the screen is capable of folding at a folding line corresponding between the projection units themselves, and is configured as each areas of the screen, which are partitioned with the folding line, being kept in an approximately constant positional relationship with each projection units regardless of holding, and is arranged to be capable of taking a plurality of folding positions with different folding angles as a whole.

Also, the above-mentioned another object of the present invention can be achieved by a method of adjusting a display device including a plurality of projection units being configured as combining a display element, and a lens array for projecting an image on the display element, as to be in a predetermined positional relationship, a screen of which images from the plurality of projection units are projected onto each separate areas, correction information storage means for storing a chromaticity correction value and a luminance correction value for each display element of which the plurality of projection units have signal correcting means for correcting a video signal according to a display element based on the chromaticity correction value and luminance correction value, and display element driving means for outputting a corrected video signal to a corresponding display element to cause it to display, wherein the screen is capable of folding at a folding line corresponding between the projection units themselves, and is configured as each areas of the screen, which are partitioned with the folding line, being kept in an approximately constant positional relationship with each projection units regardless of holding, and is arranged to be capable of taking a plurality of folding positions with different folding angles as a whole, the method comprising the steps of picking up an image projected onto the screen, and measuring a chromaticity and a luminance based on a video signal thereof, calculating the chromaticity correction value and luminance correction value such that a chromaticity and a luminance for each of display elements are uniformed on a whole screen based on the measured chromaticity and luminance; and storing the calculated chromaticity correction value and luminance correction value into the correction information storage means.

Further, yet the above-mentioned another object of the present invention can be achieved by A cellular phone which is provided with a display device including a plurality of projection units being configured as combining a display element, and a lens array for projecting an image on the display element, as to be in a predetermined positional relationship, a screen of which images from the plurality of projection units are projected onto each separate areas, wherein the screen is capable of folding at a folding line corresponding between the projection units themselves, and is configured as each areas of the screen, which are partitioned with the folding line, being kept in an approximately constant positional relationship with each projection units, and is arranged to be capable of taking a plurality of folding positions with different folding angles as a whole, the cellular phone comprising an operation button provided on one side of a case having a plurality of surfaces, for implementing a main operation, and a folding unit provided on a surface of a side opposite to a surface on which the operation button is provided, for folding the display device, wherein the cellular phone is configured as being capable of taking a close position of which a plurality of projection units themselves are folded to a location at where they are faced each other in an approximately parallel, and an open position of being opened to a degree of which the images projected from a plurality of projection units onto each separate areas of the screen can be observed simultaneously, and wherein the operation button is configured to be operable at the close position as well as to be operable at the open position.

The above and other objects, features and advantages of the invention will become more apparent from the following description when taken in conjunction with the accompanying drawings.

### BRIEF DESCRIPTION OF THE DRAWINGS

FIG. 1A is a perspective view showing a state in which a display device in a first embodiment according to the present invention is at a close position;

FIG. 1B is a perspective view showing a state in which the display device in the first embodiment according to the present invention is at an open position;

FIG. 2 is a view showing a main part of an interior structure of the display device in the above-mentioned embodiment;

FIG. 3 is a view showing a state of projecting an image of a LCD by a lens array, in the above-mentioned embodiment;

FIG. 4A is a view showing a state of a visual image on the LCD, in the above-mentioned embodiment;

FIG. 4B is a view showing a state of an image of the visual image block projected onto a screen, in the above-mentioned embodiment;

FIG. 5 is a view showing another example of the main part of the interior structure of the display device in the above-mentioned embodiment;

FIG. 6 is a view showing a state of projecting an image of an EL element by the lens array in the above-mentioned FIG. 5;

FIG. 7 is a perspective view showing a state of folding the display device of the structure such as shown in the above-mentioned FIG. 2;

FIG. 8 is a view showing one example of a structure for adjusting the display device in the above-mentioned embodiment;

FIG. 9 is a block diagram showing one example of an electrical structure for adjusting the display device in the above-mentioned embodiment;

FIG. 10A is a view showing one structural example when applying the display device which is capable of folding, to a cellular phone, in the above-mentioned embodiment;

FIG. 10B is a view showing one structural example when applying the display device which is capable of folding, to the cellular phone, in the above-mentioned embodiment;

FIG. 11A is a view showing other structural example when applying the display device which is capable of folding, to the cellular phone, in the above-mentioned embodiment;

FIG. 11B is a view showing other structural example when applying the display device which is capable of folding, to the cellular phone, in the above-mentioned embodiment; and

FIG. 12 is a view showing a structural example of a display device, which is capable of folding at two places in the above-mentioned embodiment.

### DESCRIPTION OF THE PREFERRED EMBODIMENTS

In the following, an embodiment of the present invention will be described with reference to the accompanying drawings.

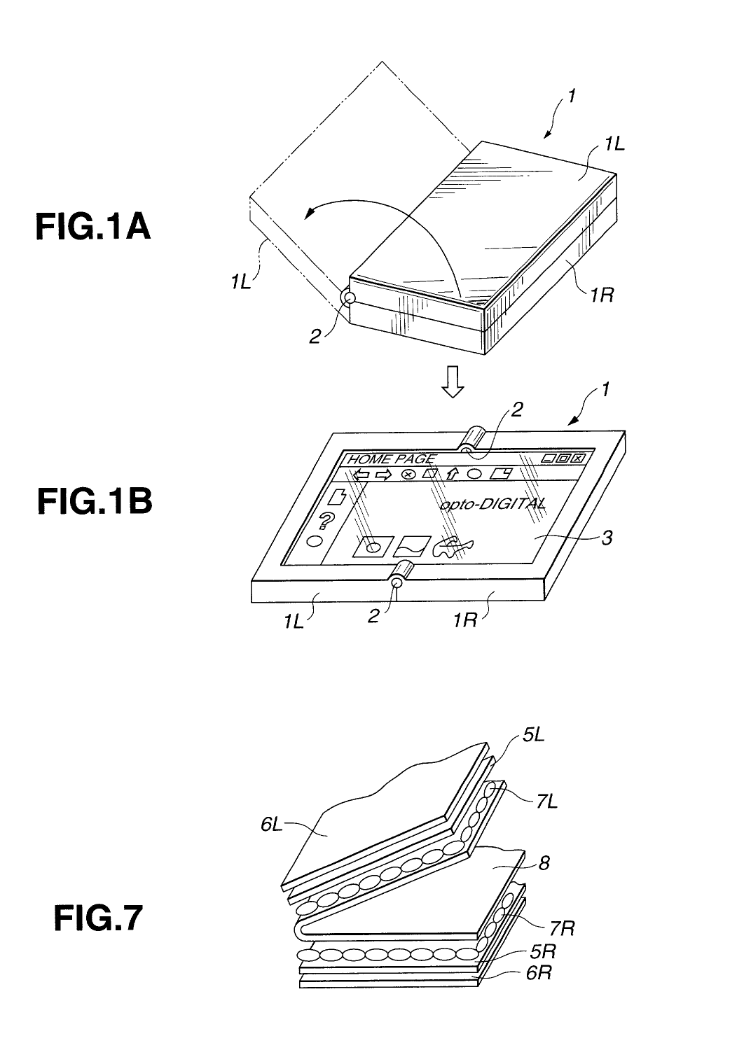

FIG. 1A through FIG. 12 show one embodiment of the present invention, and FIG. 1A, FIG. 1B are perspective views showing the states in which a display device is at a close position, and at an open position, respectively;

This display device 1 is assumed to be one which is applied to, for example, a portable information terminal device and the like in the present embodiment, and as shown in FIG. 1A and FIG. 1B, it is configured in that a left side enclosure 1L that makes in an approximately plate shape, and a right side enclosure 1R that forms a left-right pair with the left side enclosure 1L and that makes an approximately plate shape similarly, are connected so as to enabling them to open/close by a hinge unit 2 which is a folding unit, and the hinge unit 2 defines a folding line.

Then, a display unit 3 is provided so that it makes up most parts of an area of a main surface of the display device 1 when it is at the open position, across both of the above-mentioned left side enclosure 1L and the right side enclosure 1R.

In the configuration described above, for example, by opening the left side enclosure 1L around the above-mentioned hinge unit 2, it makes possible to move the display device 1 from a state of being at the close position as shown in FIG. 1A to a state of being at the open position.

Conversely, by closing around the above-mentioned hinge unit 2, it makes possible to move the display device 1 from the state of being at the open position as shown in FIG. 1B to the state of being at the close as shown in FIG. 1A, and at the close position, although a thickness becomes approximately double thickness, the area of the main surface can be reduced to an approximately one-half, thereby making it a convenient form for carrying and the like.

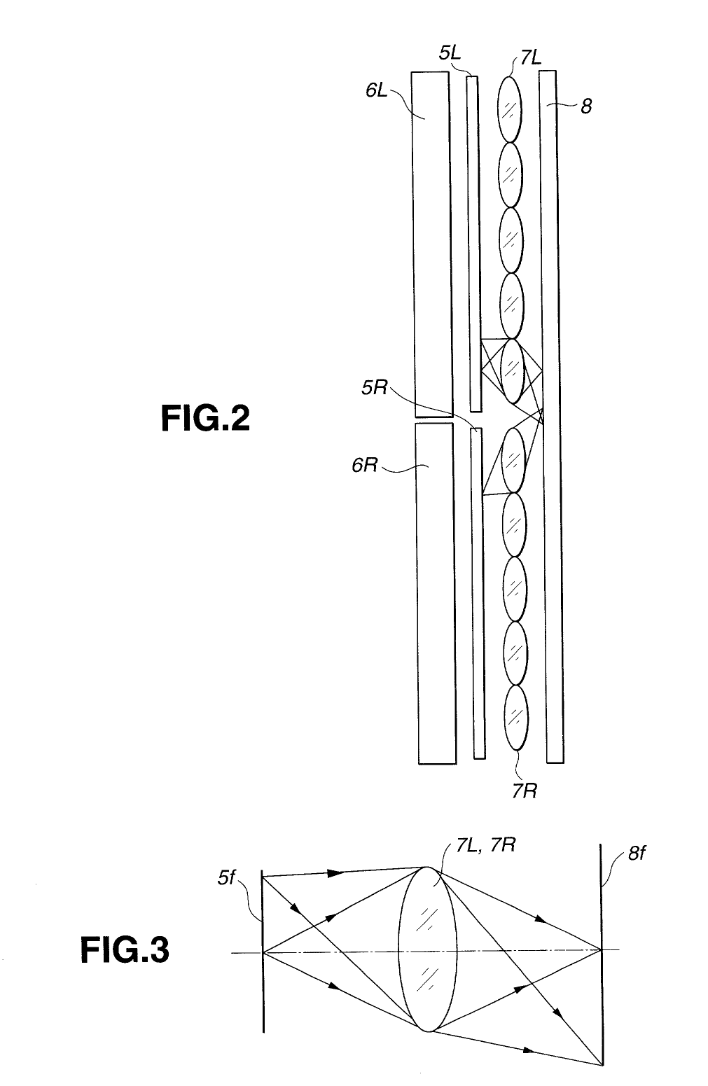

FIG. 2 is a view showing a main part of an interior structure of the above-mentioned display device 1.

This display device 1 is in that a projection unit on a left side is configured by combining a LCD 5L that is a display element, a back light 6L for illuminating the LCD 5L, and a lens array 7L for projecting an image on the LCD 5L illuminated by the back light 6L, and similarly, a projection unit on a right side is configured by combining a LCD 5R that is a display element, a back light 6R for illuminating the LCD 5R, and a lens array 7R for projecting an image on the LCD 5R illuminated by the back light 6R.

The projection unit on the left side is accommodated within the above-mentioned left side enclosure 1L, and on one hand, the projection unit on the right side is accommodated within the above-mentioned right side enclosure 1R.

Images to be projected by the left and right projection units described above are image-formed on an approximately left half area and an approximately right half area of a screen 8, respectively. The screen 8 is configured as a single member in a size of covering an entire surface of the above-mentioned display unit 3 that is provided across the above-mentioned left side enclosure 1L and right side enclosure 1R.

A technique which may display one visual image with an entire screen, by projecting the visual image appeared with a plurality of such display elements, onto the screen by the lens array, is disclosed in the Japanese Patent Application No. 11-330207, filed by the present applicant.

FIG. 3 is a view showing a state of projecting an image of the LCD by the lens arrays.

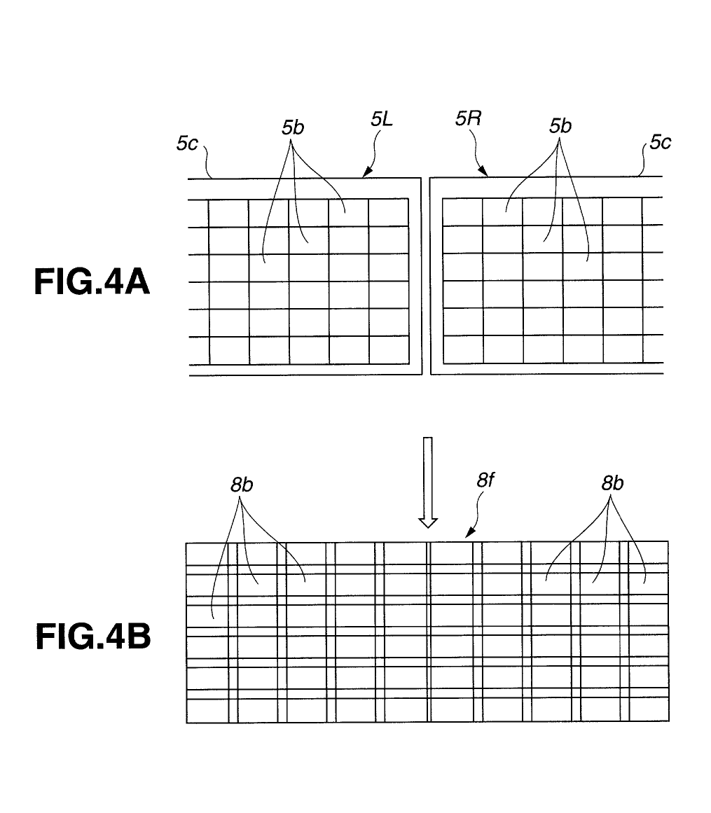

The above-mentioned lens arrays 7L, 7R are configured to arrange a plurality of lenses that corresponds to the visual image block 5b (see FIG. 4A) to be described later in a matrix form, respectively, and are formed by joining the plurality of lenses in an array shape, for example, or by integrally molding the plurality of lenses.

Each lens that constitutes the lens arrays 7L, 7R is configured as a magnifying optical system as shown in FIG. 3, and an optical axis thereof is placed so as to be perpendicular to the display surfaces of the LCD 5L, 5R.

As a result, the visual images displayed on the surfaces 5f of the LCD 5L, 5R, are projected onto a surface 8f of the screen 8 as being scaled up 1.1 ≠1.4 times, for example, by the lens arrays 7L, 7R.

FIG. 4A, FIG. 4B are views showing the state of the visual image block on the LCD, and the state of the image of the visual image block projected onto the screen.

As shown in FIG. 4A, the above-mentioned LCD 5L, 5R are in that a visual image display surface which is an area in a rectangular shape surrounded by a LCD edge 5c is constituted of a plurality of visual image blocks 5b forming smaller rectangular shapes. In more detail, the pixels that constitute the LCD 5L, 5R are treated as the visual image blocks 5b by collecting them in the plural numbers, and are configured that this visual image block 5b are arranged in matrix forms within the screen.

Since the visual image block 5b displays the visual images, each of which is reversed, based on a video signal that is supplied in response (according) to each block, and the visual image for each block is magnified and projected into a direction perpendicular to the surface 8f of the screen 8 through the above-mentioned lens arrays 7L, 7R, an image by each visual image block 5b has, on the screen 8, peripheral areas that are superimposed each other with the image by the adjacent visual image block 5b.

FIG. 4B shows the state described above, and an image 8b on the screen 8 by a certain visual image block 5b is superimposed each other with an image 8b by the visual image block 5b that are adjacent thereto vertically and horizontally, with an area having a suitable width according to a magnifying power of the above-mentioned lens.

Further, although there will be occurred a gap on which no visual image is displayed as shown in FIG. 4A, between the display area of the LCD 5L and the display area of the LCD 5R, but in the stage of being projected on the screen 8, it is arrange to be displayed without occurring a gap, according to the lens arrays 7L, 7R having the above-mentioned magnifying power.

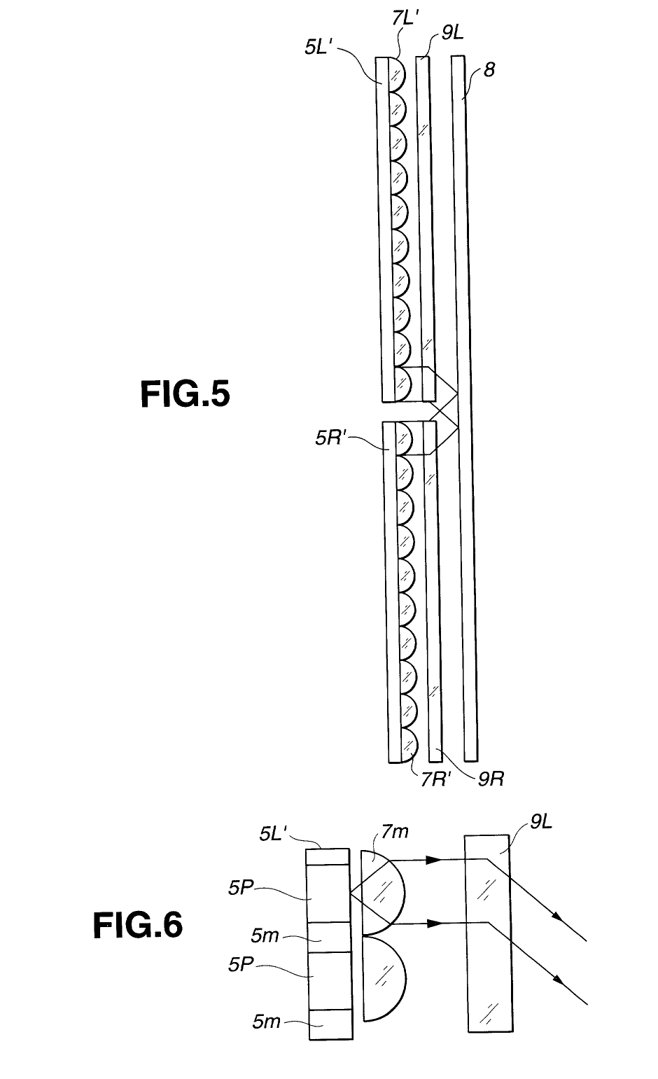

Moreover, FIG. 5 is a view showing other example of the main part of the interior structure of the display device as shown in the above-mentioned FIG. 2, and FIG. 6 is a view showing a state of projecting an image of an EL element by the lens arrays of the above-mentioned FIG. 5.

In this example, the EL elements 5L′, 5R′ are used as the display elements, and the backlights 6L, 6R such as in the example of the above-mentioned FIG. 2 are not required.

On these EL elements 5L′, 5R′, there are formed micro lens arrays 7L′, 7R′ corresponding to each pixel, and in the above-mentioned example of FIG. 2, the lens is provided for each visual image block, but in the present example, the lens is provided for each pixel.

That is, as shown in FIG. 6, on the EL elements 5L′, 5R′, there are arranged a plurality of pixels 5p in a matrix form through a-mask 5m, and the lens 7m that constitutes the above-mentioned micro lens arrays 7L′, 7R′ is provided as corresponding to each pixel 5p.

This lens 7m is provided with an optical nature for allowing a light emitted from the pixel 5p to pass through by converting it to parallel light.

The light flux passing through the above-mentioned micro lens arrays 7L′, 7R′ is incident on deflection optical elements 9L, 9R, and are bent into the directions close to each other. That is, a light beam from the EL element 5L′ is bent to a side close to the EL element 5R′, and on one hand, a light beam from the EL element 5R′ is bent to a side close to the EL element 5L′.

As a result, even though there is a part on which no visual image is displayed between the EL elements 5L′, 5R′ each other, it is arranged that an image to be projected on the screen 8 becomes a continuous one visual image.

Incidentally, herein the EL elements and the micro lens arrays for each pixel are combined, but the LCD such as shown in the above-mentioned FIG. 2 and the back light, and the micro lens arrays may be combined, or conversely, the lens array for each pixel block such as shown in the above-mentioned FIG. 2 and the EL element may be combined.

Then, FIG. 7 is a perspective view showing a state of folding the display device configured such as shown in the above-mentioned FIG. 2.

The above-mentioned screen 8 is configured as being capable of folding at a folding line corresponding between a left side projection unit constituted of the LCD 5L, the back light 6L, and the lens array 7L, and a right side projection unit constituted of the LCD 5R, the back light 6R and the lens array 7R.

This screen 8 may be configured with a material having a flexibility, but it may be arranged to be capable of folding only at the part of the above-mentioned folding line by constituting with much harder (rigid) material.

The above-mentioned left side projection unit and the right side projection unit are arranged to be folded in a form of moving integrally each other while keeping a positional relationship (alignment) of each unit interior as a constant.

At this moment, the above-mentioned screen 8 are arranged in that an area onto which an image is projected from the left side projection unit moves integrally while keeping a positional relation (alignment) with the left side projection unit, and an area onto which an image is projected from the right side projection unit moves integrally while keeping a positional relation (alignment) with the right side projection unit, respectively.

Since such the display device 1 is arranged as having a plurality of display elements, as described above, it is necessary for a chromaticity and a luminance which may be possible to generate an individual difference for each display element, to correct so as to make them to be uniform over an entire screen.

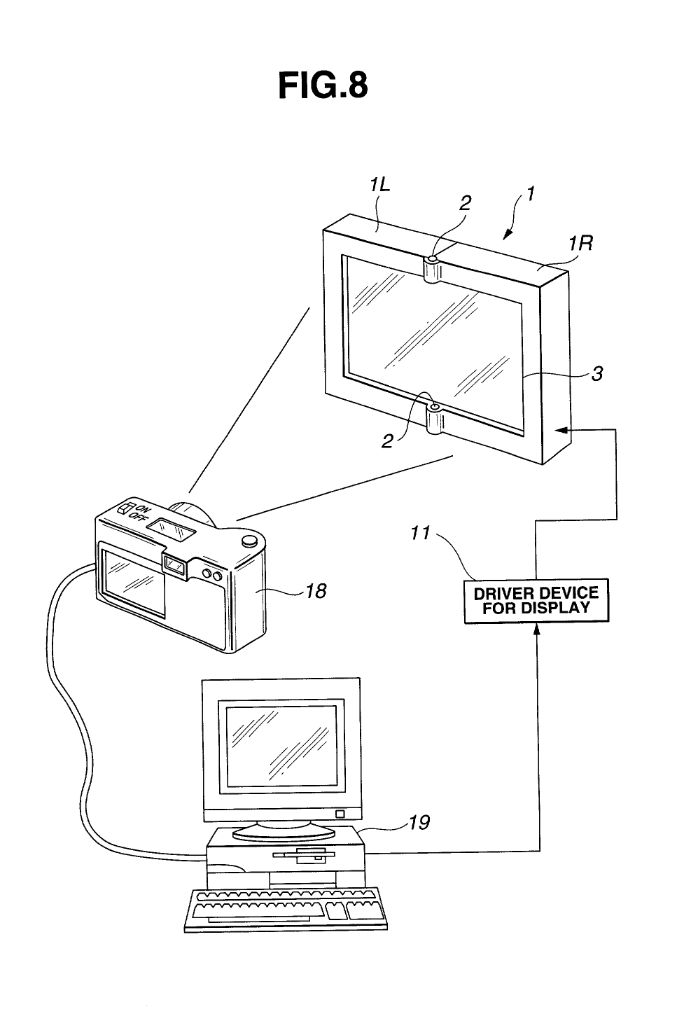

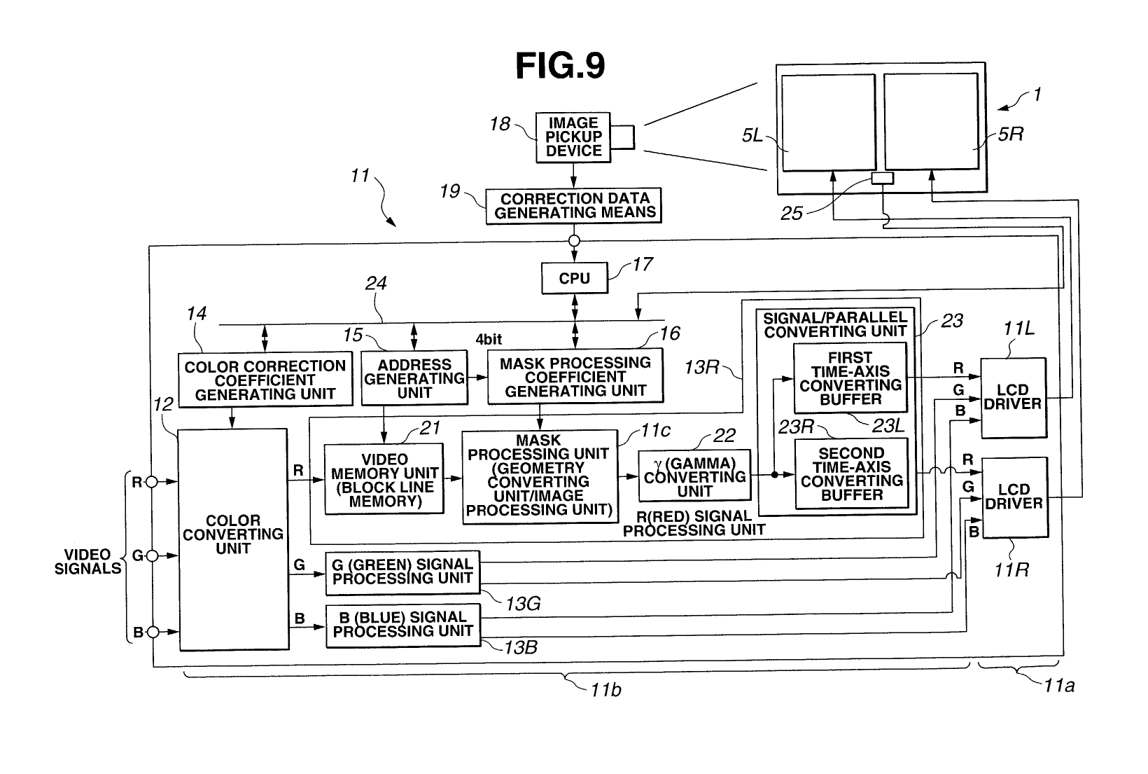

Referring to FIG. 8 and FIG. 9, it will be described about an adjustment of the display device 1, which is performed at a time when shipping and the like.

FIG. 8 is a view showing one example of a configuration for adjusting the display device, and FIG. 9 is a block diagram showing one example of an electrical configuration for adjusting the display device.

As displaying, for example, a pattern for use in test on the display device 1, this visual image is picked up by the image pickup device 18 that is constituted of a digital camera or a line scanner and the like, and is input into a correction data producing means 19 that is constituted of a personal computer and the like.

In the correction data producing means 19, the chromaticity and the luminance are measured based on the visual image data picked up, and a chromaticity correction value and a luminance correction value are calculated based on the measured chromaticity and luminance, so as to make the chromaticity and the luminance for each display element to be uniform over the entire screen 8 of the display device 1.

In more details, the correction data producing means 19 is configured to create a color converting matrix data and a δ (gamma) correction data as color correction values to be used at a time of implementing a color correction, a geometry converting address data to be used at a time of implementing a correction regarding a positional shift (misalignment) of a visual image and the like, and a shading correction data as a luminance correction value to be used at a time of implementing a correction regarding the brightness of a video, and the like.

The data of the calculated chromaticity correction value and luminance correction value and the like are input and stored in the driver device 11 for use in display, and the driver device 11 for use in display is configured to display a visual image of uniform chromaticity and luminance over the entire screen by correcting a video signal based on these correction values.

The above-mentioned driver device 11 for use in display is, as shown in FIG. 9, constituted of an visual image converting unit 11b for implementing a predetermined signal processing and the like on the input video signal, a LCD driving unit 11a that is display element driving means constituted of LCD drivers 11L, 11R for implementing the respective driving controls and the like of the above-mentioned LCD 5L, 5R as corresponding thereto, a CPU 17 that is control means for controlling the entire driver device 11 for use in display, and arithmetic coefficient generating means for generating a predetermined arithmetic coefficient and the like based on the correction data produced by the above-mentioned correction data producing means 19.

Also, the above-mentioned arithmetic coefficient generating means is constituted of a color correction coefficient generating unit 14 that is correction information storage means for storing the chromaticity correction value output from the above-mentioned correction data generating means 19 and for generating a color correction coefficient based on the chromaticity correction value, an address generating unit 15 for generating an address of a pixel data and for outputting it to a visual image memory unit 21 to be described later, and a mask processing coefficient generating unit 16 that is correction information storage means for storing the above-mentioned luminance correction value and for generating each arithmetic coefficient and the like that is used for implementing a mask processing, and for outputting them to a mask processing unit 11c to be described later. The color correction coefficient generating unit 14, the address generating unit 15 and the mask processing coefficient generating unit 16 are connected to the above-mentioned CPU 17 through a bus 24.

Further, an angle sensor 25 that is bent angle detecting means for detecting an angle formed by the left side enclosure 1L and the right side enclosure 1R provided within the above-mentioned display device 1 is connected to the bus 24.

The above-mentioned visual image converting unit 11b is constituted of a color converting unit 12 for implementing a color converting process so as to eliminate an unevenness of the chromaticity generated for each LCD or each pixel from the video signal input as an RGB signal, based on the color correction coefficient generated by the above-mentioned color correction coefficient generating unit 14, and an R (Red) signal processing unit 13R, a G (Green) signal processing unit 13G, and a B (Blue) signal processing unit 13B for receiving color signals output from the color converting unit 12 and for implementing a signal processing for each color.

Then, the above-mentioned R signal processing unit 13R is constituted of a visual image memory unit 21 composed of a block line memory and the like for storing a R signal data for one screen input from the above-mentioned color converting unit 12, a mask processing unit (geometry converting unit/visual image processing unit) 11c that is signal correcting means as well as distortion correcting means for implementing a mask processing such as a geometry converting process, an enhance process, a shading correcting process, a seamless process and the like, based on the arithmetic coefficient input from the above-mentioned mask processing coefficient generating unit 16, a δ converting unit 22 for implementing a δ converting process in response to a δ (gamma) value set for each LCD, and a serial/parallel converting unit 23 composed of a first time-axis converting buffer 23L and a second time-axis converting buffer 23R, and for implementing a signal dividing process so as to enable color signals to be output in parallel for each LCD 5L, 5R.

Further, in FIG. 9, only the interior structure of the R signal processing unit 13R is drawn in more detail, but the G signal processing unit 13G as well as the B signal processing unit 13B are also configured in a similar manner.

As described above the driver device 11 for use in display is configured to dividing-process a video signal representing a single video into a plurality of video signals corresponding to a plurality of LCD 5L, 5R, as well as, to implement a converting process and a correction process in that the videos projected from these LCD 5L, 5R are displayed on the screen 8 as a continuous single visual image.

Moreover, in FIG. 8 and FIG. 9, the driver device 11 for use in display is described as a separate block from the display device 1 for the sake of convenience, but of course it may be configured as the driver device 11 for use in display to be incorporated within the display device 1.

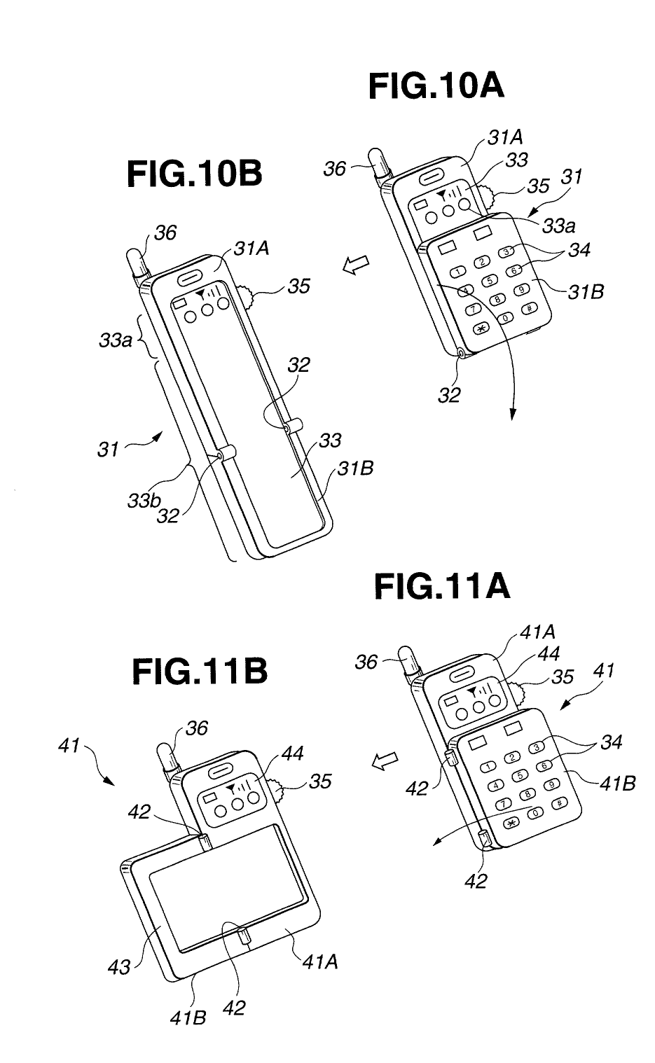

In the following, FIG. 10A, FIG. 10B are views showing one structural example when applying a display device which is capable of folding to a cellular phone.

The cellular phone 31 is configured as enabling it to take a close position of which a plurality of projection units are folded to a location at where they are faced each other in an approximately parallel, as shown in FIG. 10A, and a open position as being opened in such a degree that the images projected from the plurality of projection units onto each of the separate areas of the screen can been observed simultaneously, as shown in FIG. 10B.

Further, in FIG. 10B, as an open position, a folding position is shown as being opened in a degree of making an approximately plane, but it is not limited to this, a folding position as being opened with a suitable angle may be set as an open position.

The cellular phone 31 is constituted of an upper enclosure 31A and a lower enclosure 31B that are cases, and is configured to be connected as being capable of opening/closing with a folding line defined by a hinge unit 32 that is a folding unit.

To the cellular phone 31, there is equipped with a display unit 33 of a large area as shown in FIG. 10B, but when it is at the close position as shown in FIG. 10A, as being covered with the lower enclosure 31B, only a portion of the display unit 33 is exposed from the upper enclosure 31A, and it is configured as a display unit 33a for use in telephone function.

Further, when it is at the close position as shown in FIG. 10A, a push button 34 that is provided at the lower enclosure 31B is located at a surface on the same side as the above-mentioned display unit 33a for use in telephone function and is operable.

The above-mentioned upper enclosure 31A is configured in that on a right side thereof a rotary type dial button 35 that is an operational button is provided, and at an upper left thereof a retractable antenna 36 is provided, respectively.

The display unit 33 is configured to occupy (make up) the most parts of the area, of the main surface that forms a large area as being constituted of the upper enclosure 31A and the lower enclosure 31B, when it is taken at the open position as shown in FIG. 10B, and at the open position, the display unit 33a for use in telephone function and an extended display unit 33b are exposed as being observable.

When taking this open position, it becomes a suitable state (condition) for connecting to the Internet and the like through a telephone line, for example, and thus the above-mentioned dial button 35 may be used effectively for implementing a main operation of a browser software.

On one hand, at the close position as shown in FIG. 10A, a display is implemented only on the above-mentioned display unit 33a for use in telephone function, and the extended display unit 33b and the back light and the likes are turned off, thereby being configured as to plan a reduction of the power consumption and the like.

When it is at the close position, the above-mentioned dial button 35 is also used for an operation related to a telephone function, and is configured to be used for a selective decision of a registered party to be telephoned, and a selective decision of a mode, and the like.

FIG. 11A, FIG. 11B are views showing other structural examples when applying the display device, which is capable of folding to the cellular phone. In FIG. 11A, FIG. 11B, for the same parts as the ones in the above-mentioned FIG. 10A, FIG. 10B, the same reference numerals are used, and the descriptions thereof are omitted.

The cellular phone 41 is configured as enabling it to take a close position of which a plurality of projection units are folded to a location at where they are faced each other in an approximately parallel, as shown in FIG. 11A, and a open position as being opened in such a degree that the images projected from the plurality of projection units onto each of the separate areas of the screen can been observed simultaneously, as shown in FIG. 11B, but the example shown in the above-mentioned FIG. 10A, FIG. 10B is configured to open to up and down, and on the other hand, the example shown in FIG. 11A, FIG. 11B is configured to open to right and left.

The cellular phone 41 is constituted of a right side enclosure 41A and a left side enclosure 41B, and is configured to be connected as being capable of opening/closing with a folding line defined by a hinge unit 42 that is a folding unit.

To the cellular phone 41, there is equipped with a display unit 43 of a large area as shown in FIG. 11B, as well as, separated from the display unit 43, when it is also at the close position as shown in FIG. 11A, a display unit 44 for use in telephone function is provided at a location on the right side enclosure 41A without being covered with the left side enclosure 41B.

Further, when it is at the close position as shown in FIG. 11A, a push button 34 that is provided at the left side enclosure 41B is located at a surface on the same side as the above-mentioned display unit 44 for use in telephone function and is operable.

The above-mentioned right side enclosure 41A is configured in that on a right side thereof that is surface opposite to the above-mentioned hinge unit 42 a rotary type dial button 35 is provided, and at an upper left thereof a retractable antenna 36 is provided, respectively.

The display unit 43 is configured to occupy relatively the most parts of the area, of the main surface that forms a large area as being constituted of the right side enclosure 41A and the left side enclosure 41B, when it is taken at the open position as shown in FIG. 11B, and since the hinge unit 42 is provided on the side of the cellular phone 41 that forms a relatively oblong shape, and it makes possible to make the display unit 43 to be a screen with an aspect ration of an easy to see.

When taking this open position, it becomes a suitable state for connecting to the Internet and the like through a telephone line, for example, and thus the above-mentioned dial button 35 may be used effectively for implementing a main operation of a browser software.

In the example shown in FIG. 11A, FIG. 11B, the hinge unit 42 is provided on the left side and the dial button 35 is provided on the right side, but conversely, it is possible to provide the hinge unit on the right side and to place the dial button on the left side.

When it is at the close position as shown in FIG. 11A, the above-mentioned dial button 35 is also used for an operation related to a telephone function, and is configured to be used for a selective decision of a registered party to be telephoned, and a selective decision of a mode, and the like.

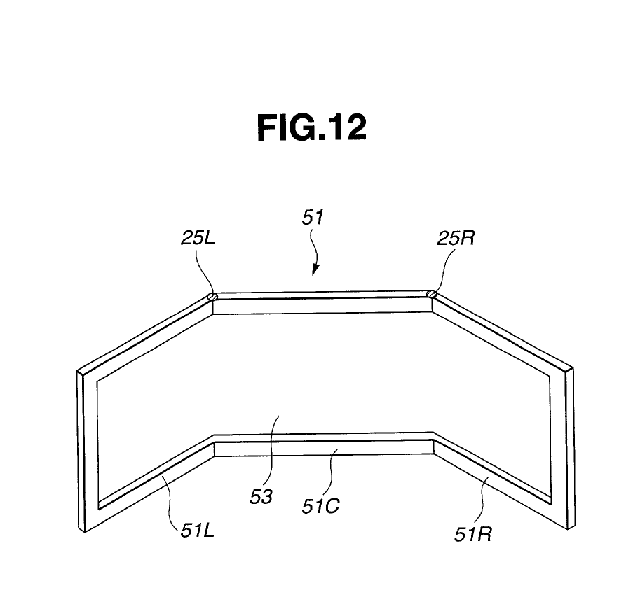

Then, FIG. 12 is a view showing a structural example of a display device, which is capable of folding at two places.

The display device 51 is configured to be a monitor device as used by connecting to a personal computer, for example, and is configured to have a left side enclosure 51L, a central enclosure 51C, and a right side enclosure 51R, and it is arranged in that the left side enclosure 51L and the central enclosure 51C are capable of opening/closing, as well as the central enclosure 51C and the right enclosure 51R are also capable of opening/closing when opening the display device 51 at the folding position with a suitable angle, the display unit 53 provided across the left side enclosure 51L, the central enclosure 51C, and the right side enclosure 51R is configured to be able to display one visual image as a whole.

In the structure described above, an angle sensor 25L that is a folding angle detecting means is provided at a folding part between the left side enclosure 51L and the central enclosure 51C, and similarly, an angle sensor 25R that is a folding angle detecting means is provided at a folding part between the central enclosure 51C and the right side enclosure 51R.

These angle sensors 25L, 25R are the same one as the angle sensor 25 shown in the above-mentioned FIG. 9, and are configured in that the detected angle information is input into the above-mentioned mask processing coefficient generating unit 16.

As the mask processing coefficient generating unit 16 generates processing coefficients for correcting a distortion which may be generated in a visual image to be projected in the neighborhood of the folding line, based on the angle information, and outputs it them to the above-mentioned mask processing unit 11c, the vide signals are converted so that an image of which a distortion is corrected is projected onto the folded screen, in the mask processing unit 11c.

As configuring to fold at two places described above, it becomes a display device in a small storage size although it has a large screen. Further, since the folding part on the left side and the folding part on the right side can be folded independently, it makes possible to seen the screen by adjusting to a desirable angle, according to a space of a desk on which it is placed and the like. At this moment, because a distortion correction is made as corresponding to an angle, an image to be projected onto the screen can be easily observed.

According to the embodiment described above, it makes possible to plan to be a portable by folding at a time of a storage, and it also makes possible to be blessed with one visual image of a seamless large screen as a whole.

Further, using the magnifying optical system and/or the deflection optical element, it makes possible to obtain a smooth visual image without affecting the visual image on the screen by the joints of the visual images themselves, the pixels themselves, and the display elements themselves.

Moreover, since it is configured to correct the chromaticity and the luminance for each display element, it makes possible to configure a smooth and a seamless one visual image as a whole, without depending on an individual difference of the display element.

Then, it is configured to detect a folding angle and then to correct a distortion of a visual image according thereto, it makes possible to observe a smooth and a seamless one visual image, without depending on the folding angle.

Additionally, in the configuration of which a portion of the display device is exposed at the close position, since it is arranged to inhibit a display of the display area that is not being exposed and a turning on the back light, it makes possible to reduce a unnecessary power consumption.

Further, when applying the display device to the cellular phone, it could be a different screen size, in the case of functioning as a telephone, and in the case of connecting to the Internet, for example, as a much larger screen being needed, and thus it makes possible to change a usage form as required.

Moreover, since the hinge unit for folding the display unit is provided on the surface opposite to the surface on which the dial button is provided, it makes possible to operate with the operation button both at the open position and at the close position.

Having described the preferred embodiments of the invention referring to the accompanying drawings, it is to be understood that the invention is not limited to those precise embodiments and that various changes and modifications thereof could be effected by one skilled in the art without departing from the spirit or scope of the invention as defined in the appended claims.

What is claimed is:

1. A display device, comprising:
a plurality of projection units being configured as combining a display element, and a lens array for projecting an image on the display element, as to be in a predetermined positional relationship;
a screen of which images from the plurality of projection units are projected onto the each separate areas;
wherein the screen is capable of folding at a folding line corresponding between the projection units themselves, and is configured as each areas of the screen, which are partitioned with the folding line, being kept in an approximately constant positional relationship with each projection units regardless of holding, and is arranged to be capable of taking a plurality of folding positions with different folding angles as a whole.

2. A display device according to claim 1, wherein the images from the plurality of projection units are configured as seamless one visual image as a whole, by being projected onto each of separate areas on the screen, as having partially superimposed areas in the portions adjacent to each other.

3. A display device according to claim 1, wherein the lens array is configured for magnifying and for projecting an image on the display element.

4. A display device according to claim 1, wherein the projection unit is arranged to have deflecting means on an optical path between the display element and the screen, and
wherein the deflecting means is configured for deflecting an image projected by the projection unit in a direction close to an image projected from an adjacent projection unit.

5. A display device according to claim 1, wherein the lens array is configured so as to arrange lenses corresponding to respective pixels of the display element.

6. A display device according to claim 1, wherein the display element is configured so as to appear a video for each visual image block, by dividing a display area into a plurality of visual image blocks, and
the lens array is configured so as to arrange respective lenses corresponding to the visual image blocks.

7. A display device according to claim 1, further comprising:
correction information storage means for storing a chromaticity correction value and a luminance correction value for each display element of which the plurality of projection units have;
signal correcting means for correcting a video signal according to a display element, based on the chromaticity correction value and luminance correction value; and
display element driving means for outputting a corrected video signal to a corresponding display element, to cause it to display.

8. A display device according to claim 1 further comprising:
folding angle detecting means for detecting a folding angle at a folding position of which the display device takes; and
distortion correcting means for correcting a distortion of an image projected near a folding line of the screen according to a folding angle detected by the folding angle detecting means.

9. A display device according to claim 1, wherein as the folding position, it is configured as being capable of taking a position of making an approximately plane shape of which a folding angle is to be an approximately 180°.

10. A display device according to claim 1, wherein the display device is configured so as to be capable of taking a close position of which a plurality of projection units themselves are folded to a location at where they face each other in an approximately parallel, and an open position of being opened in a degree of which the images projected from a plurality of projection units onto each of separate areas of the screen can be observed simultaneously,
a display state is changed so that at the close position, at least a portion of the screen is observably exposed, and the video is projected only onto the exposed screen area, and at the open position, the video is projected onto a whole surface of the screen.

11. A method of adjusting a display device is a method of adjusting a display device according to claim 7, the method comprising the steps of:
picking up an image projected onto the screen, and measuring a chromaticity and a luminance based on a video signal thereof;
calculating the chromaticity correction value and luminance correction value such that a chromaticity and a luminance for each of display elements are uniformed on a whole screen based on the measured chromaticity and luminance; and
storing the calculated chromaticity correction value and luminance correction value into the correction information storage means.

12. A cellular phone which is provided with a display device according to claim 1, the cellular phone comprising:
an operation button provided on one side of a case having a plurality of surfaces for implementing a main operation; and
a folding unit provided on a surface of a side opposite to a surface on which the operation button is provided for folding the display device,
wherein the cellular phone is configured so as to be capable of taking a close position of which a plurality of projection units themselves are folded to a location at where they face each other in an approximately parallel, and an open position of being opened to a degree of which the images projected from a plurality of projection units onto each of separate areas of the screen can be observed simultaneously, and
wherein the operation button is configured to be operable at the close position as well as to be operable at the open position.
